(19) United States
(12) Patent Application Publication
(10) Pub. No.: US 2007/0243362 A1
(43) Pub. Date: Oct. 18, 2007

(54) Sheet stock and cards made from recycled plastic scrap material and methods

(75) Inventor: Rodd S. Gilbert, Solon, OH (US)

Correspondence Address: Matthew P. Dugan, Esq.;Fay, Sharpe, Fagan, Minnich & McKee, LLP, Seventh Floor, 1100 Superior Avenue, Cleveland, OH, 44114-2579, US

(73) Assignee: Earthworks Systems, LLC

(21) Appl. No.: 11/405,300

(22) Filed: Apr. 17, 2006

(51) Int. Cl. B32B 27/00; B29C 47/00

(52) U.S. Cl. 428/195.1; 428/411.1; 264/911; 264/140; 264/148

(57) ABSTRACT

Plastic cards constructed from a material comprising recycled scrap material. The recycled scrap material may be provided from a variety of sources including plastic cards constructed from virgin polymeric material, plastic cards comprising recycled scrap material, and scrap polymeric material generated during processing of virgin polymeric material and/or recycled scrap polymeric material, and combinations thereof. A method for forming plastic cards comprising recycled scrap material comprises recovering scrap polymeric material, regrinding the scrap polymeric material to provide recycled scrap particles, forming a plastic sheet from the recycled scrap particles, and forming plastic cards from the sheet.

### BACKGROUND

The present application broadly relates to plastic card stock and cards constructed, at least in part, from material comprising recycled plastic scrap material and to processes for manufacturing and recycling the same.

Plastic cards are becoming more prevalent in a variety of applications. Therefore, as the number of cards being produced increases, the amount of scrap material resulting from processing plastic cards and from discarded plastic cards themselves continues to increase. It is estimated that over 18 million tons of plastic waste is produced every year, and it is estimated that at least about 400,000,000 lbs. of that waste is attributable to the production and/or use of plastic cards, such as transaction, information and identification cards, for example. Ongoing efforts are being made to improve the quality of the environment by maximizing the usage of virgin polymeric materials during manufacturing operations and minimizing the generation of scrap and/or other waste materials.

For example, the manufacturing processes used to prepare plastic cards, such as transaction cards (e.g., credit cards, gift cards and debit cards), identification cards (e.g., driver licenses, membership cards, and security badges), information cards (e.g., promotional and marketing cards), and other plastic cards, including those having information stored thereon, such as on a magnetic strip, for example, result in significant production of scrap material in addition to the desired product. Such scrap or waste material can include set-up sheets, edge trim, skeletons from punching and/or die cutting, hole slugs, discarded product due to quality or overruns, waste from high dies, round corner waste, sheets rejected from lamination, waste sheets from printing and/or butt rolls of overlay, for example.

Conventional or standard plastic card manufacturing processes typically involve the production of relatively large, unfinished stock sheets of polymeric material. This unfinished sheet stock is normally sized to allow a plurality of plastic cards to be cut therefrom. The unfinished sheet stock is produced using any one of a variety of known manufacturing processes, such as calendaring or extruding, for example. The unfinished sheet stock is typically then cut and/or trimmed into finished sheets of stock that are sized to customer specifications or are of appropriate dimensions for further processing.

Presently, virgin PVC is the material of choice for use in the manufacture of plastic card stock and plastic cards. Other virgin homopolymeric and/or co-polymeric materials may alternately be used in some card applications. The use of virgin PVC is due at least in part to the durability and price of virgin PVC, as compared to other virgin plastic materials. However, the use of virgin material exclusively or even in a substantial or large quantity is problematic for several reasons. One reason is that the use of virgin PVC can still significantly contribute to the cost of an associated product, though it may be more economical than other virgin materials. Additionally, environmentally unfriendly additives are normally used to achieve the desired sheet or card properties and/or characteristics. Furthermore, such additives further contribute to manufacturing costs and can also introduce issues related to quality control.

For decorative, informational or other purposes, the trimmed or sized stock sheets of virgin PVC or other virgin polymers are commonly printed or otherwise at least partially coated with an ink or other marking substance. Optionally, a clear coating of ink, lacquer or another substance can be applied over the printing to seal and/or otherwise protect the same. This arrangement is particularly well suited for lower cost sheets and/or cards, such as might be used for or as promotional or advertising cards, for example.

As an alternative to clear coating, trimmed or sized stock sheets, with or without printing, can be combined with a protective overlay, such as one that includes a pre-applied magnetic strip, for example.

In one known arrangement, the overlay can include a pre-applied dry adhesive that is suitable for bonding to the specific ink or other marking substances deposited on the sheet stock or card. The use of dry adhesive is often desirable as the ink or other marking substance can undesirably influence adhesion between the virgin PVC core and the overlay. In other arrangements, however, the adhesive may be applied directly over the ink. An overlay with or without adhesive could then be applied to the trimmed sheet or plastic card on top of the pre-applied adhesive.

These various card layers form a sandwich construction, and these “sandwiches” are inserted between mirrored plates of steel, which creates—books of sandwiches and plates. The books are then inserted into vertical lamination presses that use heat and pressure to combine the sandwiches into laminated sheets of card stock. After the lamination process, the individual cards can be punched out of or otherwise formed from the laminated sheets of card stock in any suitable manner, such as by machines that are designed to handle laminated sheets, including those with uneven edges. One example of such equipment uses optical sensors to locate specific card features prior to the punching or other card separation process.

Once a plastic card is cut or otherwise separated from a laminated sheet of card stock, the plastic card may be considered finished. In other arrangements, suitable post-processing steps may be performed to further refine the card. Such post-processing steps can include hot stamping, personalization (e.g., applying names and/or numbers to the card surface and/or encoding a magnetic strip on the card), embossing, punching and scoring (i.e., providing additional internal or edge punching or cutting), for example.

Presently, the scrap material resulting from the various processing steps utilized to produce a plastic card is not known to be recycled to make sheets of plastic card stock or plastic cards. Similarly, the plastic cards themselves are not typically recycled. Rather, the cards are simply discarded after they are used for their intended purpose. Because plastic cards are simply being discarded by consumer and retailers, new plastic cards are normally manufactured from virgin material. As discussed above, there are numerous disadvantages to this arrangement.

FIG. 13 illustrates one example of a current system 50 for processing and/or using plastic cards. As shown in FIG. 13, virgin polymeric material, such as virgin polyvinyl chloride, for example, is provided, as indicated by box 52, and manufactured or processed into card stock material, such as a plastic sheet, as indicated by box 54. Individual cards are cut, punched, separated or otherwise formed from the card stock sheets, as indicated by box 56. After a card is separated from a sheet, the card may undergo post processing steps including, for example, hot stamping, personalization, embossing, scoring, or the like. Plastic cards are then provided to third parties, such as retailers, consumers or other parties, as indicated by box 58, to be used for various applications including, but not limited to use as transaction cards, information cards or identification cards, for example.

As shown in FIG. 13, scrap material may be produced at every step in conventional manufacturing processes for producing sheets of plastic card stock as well as the use of plastic cards. This scrap is generally discarded as waste WST or otherwise rendered unavailable or unusable. For example, the manufacturing or production of the sheet material 54 produces scrap 60 as a natural consequence of, for example, calendaring or extrusion processes that are typically employed to produce the sheet material. Additionally, scrap 62 results from the formation of plastic cards 56, and may include material such as set up sheets, edge trim, or skeletons from punch and/or die cutting, for example. Post-processing of the sheet of card stock, as indicated by box 64, and/or post-processing of plastic cards, as indicated by box 66, may also produce scrap indicated by boxes 68 and 70, respectively. Such scrap can include waste sheets from printing, for example. Furthermore, scrap 68 and/or 70 may also result from product overruns and/or discarded products that fails certain quality standards, for example. Further still, post-consumer handling of plastic cards 58 typically further generates scrap material 72, as the plastic cards are simply discarded after they are used for their intended purpose. Thus, the plastic cards themselves typically become waste WST deposited in a landfill or otherwise unusably disposed. As shown in FIG. 13, the scrap material, such as 60, 62, 68, 70 and/or 72, for example, is reduced to waste WST and disposed of in a manner rending the same unavailable or unsuitable for further use.

### BRIEF DESCRIPTION

In view of the foregoing, it is desirable to provide a section of plastic material, such as a sheet of plastic card stock and/or a plastic card, that comprises a reduced amount of virgin polymeric material relative to conventional constructions. Along these lines, it is desirable to provide sheets of plastic card stock and/or plastic cards constructed, at least in part, from a material comprising recycled polymeric scrap material. Additionally, it is desirable to provide a process or method for manufacturing sheets of plastic card stock and/or plastic cards that comprises utilizing and/or recycling scrap polymeric material to produce sheets of plastic card stock and/or plastic cards comprising the recycled scrap polymeric material. Furthermore, it is desirable to provide a method of recycling plastic card stock and/or plastic cards into sheets of plastic card stock and/or plastic cards.

In one embodiment in accordance with the present disclosure, a section of polymeric sheet material is provided comprising a first layer having a first surface and a second surface, the first layer being constructed from a first material comprising recycled scrap material from a single family of polymeric materials.

In another embodiment, a method of manufacturing one of a sheet of plastic card stock or a plastic card is provided, the method comprising (a) recovering scrap polymeric material; (b) regrinding the scrap polymeric material to provide recycled polymeric particles; (c) processing the recycled polymeric particles to form a section of polymeric sheet material comprising recycled scrap polymeric material; and (d) forming at least one of a sheet of plastic card stock or a plastic card from the section of polymeric sheet material.

In still another embodiment, a method for forming one of a sheet of plastic card stock or a plastic card comprising recycled scrap material is provided, the method comprising (a) recovering scrap polymeric material from a source; (b) regrinding the scrap polymeric material to provide recycled scrap polymeric particles; (c) processing the recycled scrap polymeric particles to form a section of polymeric sheet material comprising recycled scrap material; and (d) forming one of a sheet of plastic or a plastic card comprising recycled scrap material.

In yet another embodiment, a method for recycling scrap polymeric material into one of a sheet of plastic card stock or a plastic card is provided, the method comprising (a) recovering scrap polymeric material from a first party; (b) regrinding the scrap polymeric material into recycled scrap polymeric particles; (c) processing the recycled scrap polymeric particles into a section of polymeric sheet material comprising recycled scrap polymeric material; (d) processing the section of polymeric sheet material into at least one of a sheet of plastic card stock or a plastic card comprising recycled scrap polymeric material; and (e) distributing the at least one sheet of plastic card stock or plastic cards to a second party.

One exemplary embodiment of a section of material in accordance with the present novel concept is provided that includes a sheet of plastic card stock or a plastic card comprising recycled scrap material that is recovered from conventional plastic card manufacturing processes or post-consumer scrap. The plastic card may be a single layer comprising only a homogenous core of recycled scrap material or a blend of a virgin polymeric material and recycled scrap material. The plastic card may also be multi-layered, comprising a combination of homogenous or heterogeneous core materials (as a single layer or multiple layers), along with such other virgin material layers (veneers), protective overlays, additives, magnetic strips and ink or other marking substances as are desired for a particular application.

One exemplary method of manufacturing a sheet of plastic card stock or a plastic card is provided that includes recovering scrap polymeric material from a plastic card manufacturing process. The exemplary method also includes at least one of grinding, shredding or pulverizing the scrap material into plastic particles. The exemplary method further includes utilizing the plastic particles in one of a calendaring, extruding or co-extruding process to create a solid core of recycled scrap material suitable for use in forming a sheet of plastic card stock or a plastic card. The exemplary method can also optionally includes applying a veneer and/or an overlay along one or both sides of the solid core.

One exemplary method of manufacturing a sheet of plastic card stock or a plastic card is provided that includes recovering post-consumer scrap from third parties, such as retailers and/or consumers, for example, who place such plastic cards into use. The exemplary method also includes at least one of grinding, shredding or pulverizing the post-consumer scrap material into plastic particles. The exemplary method further includes utilizing the plastic particles in one of a calendaring, extruding or co-extruding process to create a solid core of recycled scrap material suitable for use in forming a sheet of plastic card stock or a plastic card. The exemplary method can optionally include applying a veneer and/or an overlay along one or both sides of the solid core.

### BRIEF DESCRIPTION OF THE DRAWINGS

These and other features, aspects and advantages will become better understood with regard to the following description, appended claims and accompanying drawings. The drawings are not to scale and the proportion of certain elements may be exaggerated for the purposes of clarity and ease of illustration.

FIG. 1 is a top view of a length of unfinished sheet stock illustrating representations of a sheet of plastic card stock and a plurality of plastic cards formable therefrom;

FIG. 2 is a cross-sectional side view of one exemplary embodiment of a section of plastic material suitable for use as a sheet of card stock or a plastic card as shown in FIG. 1 and including a single core comprising recycled scrap material;

FIG. 3 is a cross-sectional side view of an alternate embodiment of the section of plastic material in FIG. 2 that includes a single core comprising recycled scrap material and an overlay on one surface of the core;

FIG. 4 is a cross-sectional side view of another alternate embodiment of the section of plastic material in FIG. 2 that includes a single core comprising recycled scrap material and a veneer on one surface of the core;

FIG. 5 is a cross-sectional side view of still another alternate embodiment of the section of plastic material in FIG. 2 that includes a single core comprising recycled scrap material, a veneer on one surface of the core and an overlay on the outer surface of the veneer;

FIG. 6 is a cross-sectional side view of a further alternate embodiment of the section of plastic material in FIG. 2 that includes a multi-layered core comprising recycled scrap material;

FIG. 7 is a cross-sectional side view of still a further alternate embodiment of the section of plastic material in FIG. 2 that includes a multi-layered core comprising recycled scrap material and an overlay on one surface of the multi-layered core;

FIG. 8 is a cross-sectional side view of yet a further alternate embodiment of the section of plastic material in FIG. 2 that includes a multi-layered core comprising recycled scrap material and a veneer on one surface of the multi-layered core;

FIG. 9 is a cross-sectional side view of another alternate embodiment of the section of plastic material in FIG. 2 that includes a multi-layered core comprising recycled scrap material, a veneer on one surface of the multi-layered core and an overlay on the outer surface of the veneer;

FIG. 10 is a cross-sectional side view of another alternate embodiment of the section of plastic material in FIG. 2 that includes a single core comprising recycled scrap material, and a scratch-off label disposed along one surface of the core;

FIG. 11 is a representation of one exemplary process of forming a sheet of plastic card stock and/or a plastic card comprising recycled scrap material;

FIG. 12 is a representation of one exemplary process for recycling plastic card material into a section of plastic material comprising the recycled card material; and,

FIG. 13 illustrates an example of a conventional process for producing a plastic card and generating scrap material waste.

### DETAILED DESCRIPTION

The following includes definitions of selected terms employed herein. The definitions include various examples and/or forms of components that fall within the scope of a term and that may be used for implementation. The examples are not intended to be limiting. Both singular and plural forms of terms may be within the definitions.

“Overlay,” as used herein, refers to a substantially transparent, relatively thin layer of virgin polymeric material suitable for use in the manufacture of a plastic card. The overlay can be adhered by heat, pressure and/or adhesive to a core of recycled scrap material, virgin polymeric material, and/or combinations thereof or to a veneer as described herein. The overlay can optionally contain a pre-applied magnetic strip and/or a pre-applied adhesive as may be desired for a particular application.

“Plastic card” and “plastic card stock,” as used herein, refer to any approximately flat section of polymeric material of any suitable size, shape or thickness. A plastic card will normally have a smaller relative size than a sheet of plastic card stock. Plastic cards can be used for any suitable purpose and can include any suitable features or elements. For example and without limitation, plastic cards can be used as transaction cards (e.g., credit cards, gift cards, debit cards), identification cards (e.g., driver licenses, membership cards, security badges, key tags, luggage tags) and/or information cards (e.g., business cards, marketing or promotional cards). A sheet of plastic card stock is generally of a larger relative size than that of plastic cards and, for example, may be dimensioned such that one or more plastic cards could be formed from the plastic material within the boundaries thereof. Additionally, a sheet of plastic card stock and/or a plastic card can include a single polymeric layer or multiple polymeric layers. The one or more layers that comprise a sheet of plastic card stock or a plastic card can be constructed of a virgin polymeric material, recycled scrap material, and/or combinations thereof.

“Scrap polymeric material” as used herein, refers to any previously processed, used, spent or otherwise discarded polymeric material including, but not limited to, scrap resulting from processing virgin polymeric material and/or recycled scrap material, scrap resulting from the manufacture of a sheet of plastic card stock or from the manufacture of plastic cards, and/or post-consumer scrap recovered from third parties, such as in the form of spent or discarded plastic cards, for example. It will be appreciated that “scrap polymeric material” includes any polymeric material from a class or family of polymeric material that may be used to form a core for a sheet of plastic card stock and/or for a plastic card including, but not limited to, non-ethylenic olefin polymers or polyolefins, polyamides, polyvinyl chlorides, polystyrenes, nylon, polyesters, polyestercopolymers, polyurethanes, polyacrylates, polysulfones, styrene-maleic anhydride copolymers, styrene-acrylonitrile copolymers, ionomers based on sodium or zinc salts of ethylene methacrylic acid, polymethyl methacrylates, fluoroplastics, polycarbonates, polyacrylonitriles, polycyanurates, ethylene-vinyl acetate copolymers, and combinations thereof. Some specific examples of suitable polymeric materials that are used in card stock and may become “recycled scrap material,” or “scrap polymeric material” include, but are not limited to, polypropylene (PP) and/or the rigid PVC family.

“Recycled scrap material,” as used herein refers to scrap polymeric material that has been recovered from an earlier use and processed into a form that is suitable for further use in later manufacturing applications and/or processes. For example “recycled scrap material” includes, but is not limited to, scrap polymeric material that is reground into particles for subsequent processing, and individual classes or families of polymeric material that are separated or otherwise recovered from an article comprising a mixture of polymeric materials.

“Veneer,” as used herein, refers to a relatively thin layer of polymeric material, such as, for example, virgin polymeric material, suitable for use in the manufacture of a plastic card. The veneer can be adhered by heat, pressure and/or adhesive to a core of recycled scrap material, virgin polymeric material, and/or combinations thereof.

“Regrinding,” as used herein, refers to any process that may be employed to act upon scrap material to produce a sufficiently fine particle size to render the scrap material fit for use in subsequent polymeric processing methods. For example, “regrinding” includes, but is not limited to, grinding, shredding, pulverizing, and the like. The particle size produced from regrinding is not limited except to the extent that the particles should be of a size sufficient or suitable for use in a polymeric processing operation such as, for example, extrusion or calendaring processes. Particle sizes desirable or suitable for use in a particular process are readily ascertainable by a person skilled in the art.

This application describes numerous embodiments of a section of polymeric material that is suitable for use as or for use in forming a sheet of plastic card stock or a plastic card that is constructed, at least in part, from a material comprising recycled polymeric scrap material. For example, in one embodiment, a section of polymeric material that is suitable for use as or for use in forming a sheet of plastic card stock or a plastic card can be constructed from a material comprising a blend of virgin polymeric material and recycled polymeric scrap material. In another embodiment, a section of polymeric material that is suitable for use as or for use in forming a sheet of plastic card stock or a plastic card can be constructed from a material consisting essentially of recycled polymeric scrap material. In still a further embodiment, a section of polymeric material that is suitable for use as or for use in forming a sheet of plastic card stock or a plastic card can be constructed from a material consisting of recycled polymeric scrap material. A material “comprising,” “consisting essentially of,” or “consisting of” recycled scrap material is not limited to recycled scrap material from a particular class or family of polymeric materials or a particular source, but may include blends of recycled scrap material from one or more polymeric classes or families or scrap source.

As mentioned above, a plastic card and/or a sheet of plastic card stock can include a single layer or multiple layers, which include one or more core layers and can optionally include one or more veneer layers and/or one or more overlay layers. In an exemplary embodiment, at least one or more of the core layer or layers is at least partially formed from recycled polymeric scrap material, which among other benefits can reduce the cost of manufacturing plastic cards and/or plastic card stock and can reduce the overall environmental impact of the production of the same.

The recycled polymeric scrap material can include any suitable type, kind, family or group of polymer, including blends and/or mixtures thereof, that might find use in a conventional or standard plastic card manufacturing process. It will be appreciated that recycled scrap polymeric material may comprise a single family or class of polymeric material, or a blend of polymeric materials from different families or classes of polymeric material. In one embodiment recycled scrap polymeric material comprises a single family or class of polymeric materials. A single family or class of polymeric materials encompasses compositions comprising a single type of polymer. For example, a vinyl polymer, such as rigid polyvinyl chloride, can be used. Additionally, a single family or class of polymeric materials encompasses compositions comprising of blend of polymeric materials from a single family or class of polymeric material. For example, a composition comprising a single class or family of polymeric materials may include two or more different types of polyolefins. The above examples are merely for illustration and are not limiting examples of suitable polymeric material compositions.

Additionally, the recycled polymeric scrap material may also include a relatively minor amount of additives, metallic substances, laminates, inks and other substances that comprise the initial sheet of plastic card stock or that may have been added to fit the manufacturer's particular purpose. In one embodiment, to the extent they exist in the plastic card, the veneers and/or overlays are constructed of the same family of polymeric material as the recycled polymeric scrap material. However, it is conceivable that they may be constructed of a different family of polymeric material. Depending on the application, the size and thickness of the plastic cards may vary widely.

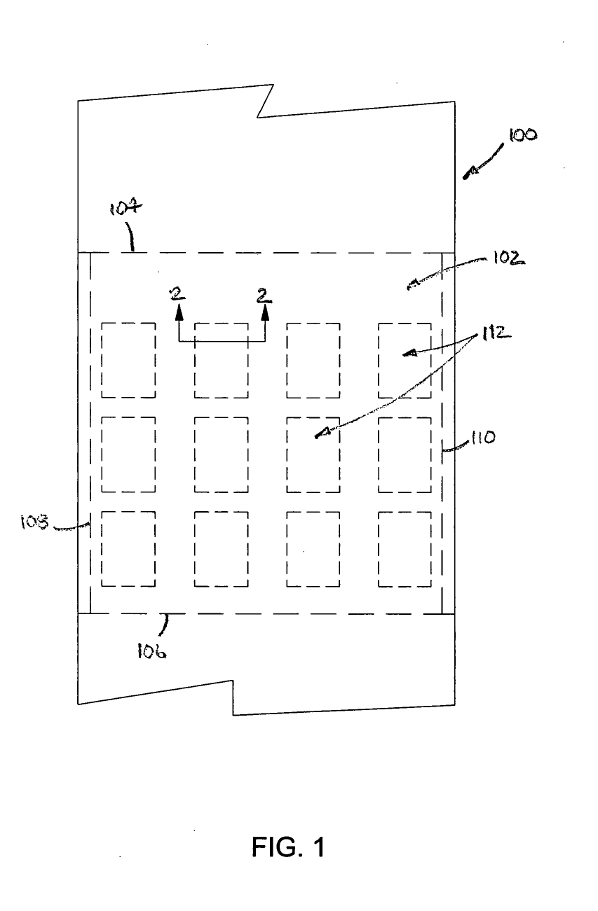

FIG. 1 is a top plan view of one exemplary embodiment of a length of unfinished sheet stock 100 formed from material comprising recycled polymeric scrap material. The unfinished sheet stock is suitable for use in forming a sheet of plastic card stock 102 from a section of polymeric material disposed between first and second trim lines 104 and 106. Optionally, sheet 102 can be further sized and/or shaped by cutting or trimming additional portions of the section of polymeric material, such as along additional third and fourth trim lines 108 and 110. The unfinished sheet stock is also suitable for use in forming one or more plastic cards 112. The plastic cards can be cut to an approximate size or shape directly from a section of polymeric material from unfinished sheet stock 100 or alternately from sheet 102, such as after further processing operations thereof, for example.

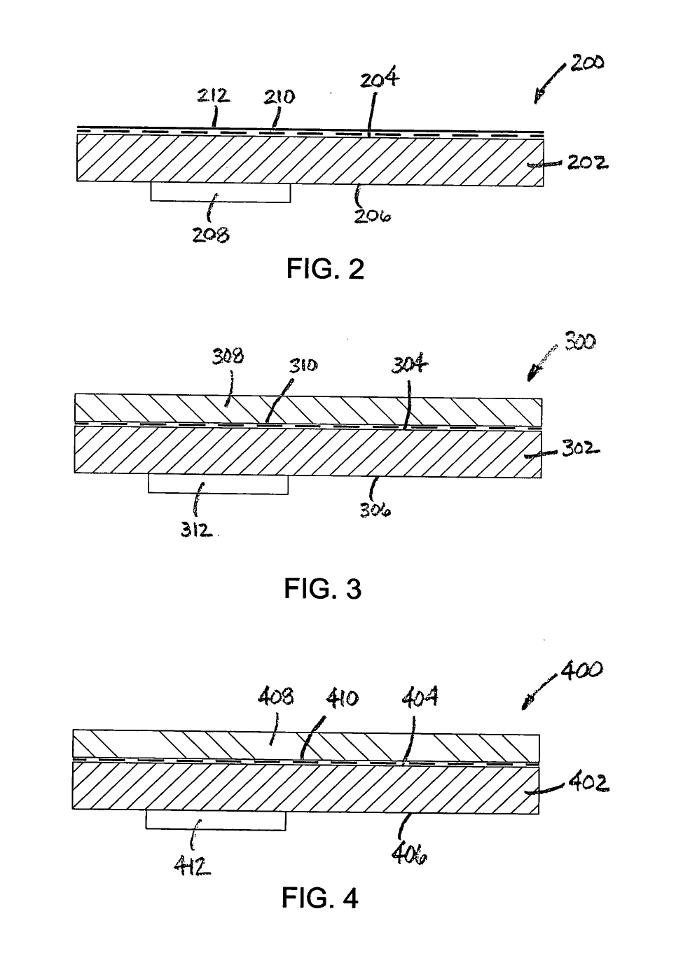

FIG. 2 is a cross-sectional side view of one embodiment of a section of polymeric material 200 that is suitable for use as a sheet of plastic card stock or a plastic card. Section of polymeric material 200 includes a first layer 202 having a first or top surface 204 and an opposing second or bottom surface 206. In one exemplary embodiment, first layer 202 can be constructed of a material comprising recycled scrap material. In another embodiment, first layer 202 can be constructed of a material comprising a mixture of recycled scrap material and virgin polymeric material.

Optionally, an information storage device can be provided on or along either one or both surfaces of the first layer. In the exemplary embodiment shown, a magnetic strip 208 is shown disposed along bottom surface 206. It will be appreciated, however, that any other suitable construction can alternately be used. Additionally, printing or marking can be provided on or along one or both of surfaces 204 and 206 of first layer 202. In the exemplary embodiment shown, printing 210 is disposed along first surface 204. An optional clear coating 212, such as ink, lacquer or another suitable substance, for example, can be applied along one or both of surfaces 204 and 206. In one exemplary embodiment, such an optional clear coating 212 extends over any printing or marking that may be included, such as printing 210, for example.

It will be appreciated that a core sheet or card may be a single ply comprising a section of polymeric material. For example, referring to FIG. 2, a core sheet or card could simply comprise a first layer such as layer 202 having a top surface 204 and an opposing or bottom surface 206, without any optional clear coating, veneer overlayer, etc., disposed over the top or bottom surface.

FIG. 3 is a cross-sectional side view of another embodiment of a section of polymeric material 300 that is suitable for use as a sheet of plastic card stock or a plastic card. Section of polymeric material 300 includes a first layer 302 having a first or top surface 304 and an opposing second or bottom surface 306. In one exemplary embodiment, first layer 302 can be constructed of a material comprising recycled scrap material. In another embodiment, first layer 302 can be constructed of a material comprising a mixture of recycled scrap material and virgin polymeric material.

In the exemplary embodiment shown in FIG. 3, section 300 includes a first overlay 308 disposed along first surface 304. Additionally, printing or marking can be provided on or along one or both of surfaces 304 and 306 of first layer 302. In the exemplary embodiment shown, printing 310 is disposed along first surface 304 and first overlay 308 extends across printing 310 substantially covering the same. As discussed above, such overlays are preferably formed from an approximately transparent material and are operative to protect the first layer as well as the printing.

Optionally, an information storage device can be provided on or along either one or both surfaces of the first layer. In the exemplary embodiment shown, a magnetic strip 312 is shown disposed along bottom surface 306. It will be appreciated, however, that any other suitable construction can alternately be used. Additionally, a second overlay (not shown) could optionally be provided and secured along second surface 306 of first layer 302. Such a second overlay would be operative to protect the second surface of the first layer, as well as protect any printing or marking that may be included along the second surface.

FIG. 4 is a cross-sectional side view of still another embodiment of a section of polymeric material 400 that is suitable for use as a sheet of plastic card stock or a plastic card. Section of polymeric material 400 includes a first layer 402 having a first or top surface 404 and an opposing second or bottom surface 406. In one exemplary embodiment, first layer 402 can be constructed of a material comprising recycled scrap material. In another embodiment, first layer 402 can be constructed of a material comprising a mixture of recycled scrap material and virgin polymeric material.

In the exemplary embodiment shown in FIG. 4, section 400 includes a first veneer 408 disposed along first surface 404 of first layer 402. Typically, the first veneer is included for informational or aesthetic purposes and, thus, includes printing or marking integrally formed thereon. However, first veneer 408 can optionally include an approximately transparent portion (not shown). Additionally, printing or other markings can be provided on or along one or both of surfaces 404 and 406 of first layer 402. In the exemplary embodiment shown, printing 410 is disposed along first surface 404 and first veneer 408 extends across printing 410 substantially covering the same.

Optionally, an information storage device can be provided on or along either one or both surfaces of the first layer. In the exemplary embodiment shown, a magnetic strip 412 is shown disposed along bottom surface 406. It will be appreciated, however, that any other suitable construction can alternately be used. Additionally, a second veneer (not shown) could optionally be provided and secured along second surface 406 of first layer 402. Such a second veneer may be disposed along the second surface to provide additional information or aesthetics, for example.

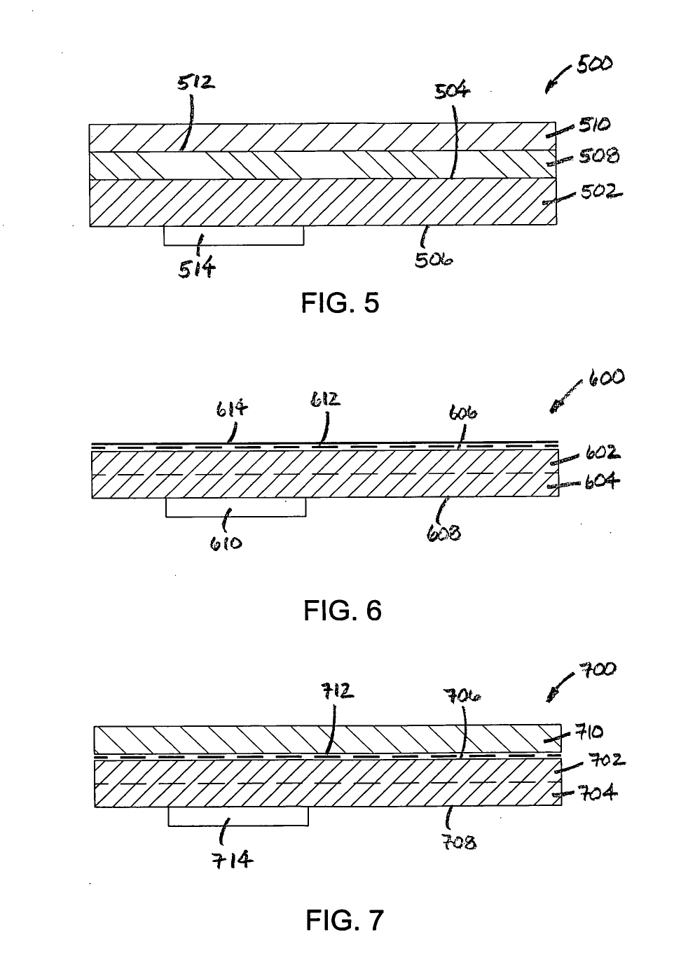

FIG. 5 is a cross-sectional side view of yet another embodiment of a section of polymeric material 500 that is suitable for use as a sheet of plastic card stock or a plastic card. Section of polymeric material 500 includes a first layer 502 having a first or top surface 504 and an opposing second or bottom surface 506. In one exemplary embodiment, first layer 502 can be constructed of a material comprising recycled scrap material. In another embodiment, first layer 502 can be constructed of a material comprising a mixture of recycled scrap material and virgin polymeric material.

In the exemplary embodiment shown in FIG. 5, section 500 includes a first veneer 508 disposed along first surface 504 and a first overlay 510 disposed along an outer surface 512 of first veneer 508. Typically, the first veneer is included for informational or aesthetic purposes and, thus, includes printing or marking (not shown) integrally formed thereon. However, first veneer 508 can optionally include an approximately transparent portion (not shown). Printing or other markings (not shown) can be provided on or along one or both of surfaces 504 and 506 of first layer 502.

Optionally, an information storage device can be provided on or along either one or both surfaces of the first layer. In the exemplary embodiment shown, a magnetic strip 514 is shown disposed along bottom surface 506. It will be appreciated, however, that any other suitable construction can alternately be used. Additionally, either one or both of a second veneer (not shown) and a second overlay (not shown) could optionally be provided and secured along second surface 506 of first layer 502. Such a second veneer, if provided, may be disposed along the second surface to provide additional information or aesthetics, for example. And, such a second overlay, if provided, may be disposed along the second surface or the second veneer to at least partially protect the same.

FIG. 6 is a cross-sectional side view of a further embodiment of a section of polymeric material 600 that is suitable for use as a sheet of plastic card stock or a plastic card. Section of polymeric material 600 includes a first layer 602, a second layer 604, a first or top surface 606, and an opposing second or bottom surface 608. In one exemplary embodiment, either one or both of first layer 602 and second layer 604 can be constructed of a material comprising recycled scrap material. In another exemplary embodiment, either one or both of first layer 602 and second layer 604 can be constructed of a material comprising a mixture of recycled scrap material and virgin polymeric material.

Optionally, an information storage device can be provided on or along either one or both surfaces of the section of polymeric material. In the exemplary embodiment shown, a magnetic strip 610 is shown disposed along bottom surface 608. It will be appreciated, however, that any other suitable construction can alternately be used. Additionally, printing or marking can be provided on or along one or both of surfaces 606 and 608 of section 602. In the exemplary embodiment shown, printing 612 is disposed along first surface 606. An optional clear coating 614, such as ink, lacquer or another suitable substance, for example, can be applied along one or both of surfaces 606 and 608. In one exemplary embodiment, such an optional clear coating 614 extends over any printing or marking that may be included, such as printing 612, for example.

FIG. 7 is a cross-sectional side view of a further embodiment of a section of polymeric material 700 that is suitable for use as a sheet of plastic card stock or a plastic card. Section of polymeric material 700 includes a first layer 702, a second layer 704, a first or top surface 706, and an opposing second or bottom surface 708. In one exemplary embodiment, either one or both of first layer 702 and second layer 704 can be constructed of a material comprising recycled scrap material. In another exemplary embodiment, either one or both of first layer 702 and second layer 704 can be constructed of a material comprising a mixture of recycled scrap material and virgin polymeric material.

In the exemplary embodiment shown in FIG. 7, section 700 includes a first overlay 710 disposed along first surface 706. Additionally, printing or marking can be provided on or along one or both of surfaces 706 and 708 of section 700. In the exemplary embodiment shown, printing 712 is disposed along first surface 706 and first overlay 710 extends across printing 712 substantially covering the same. As discussed above, such overlays are preferably formed from an approximately transparent material and are operative to protect the first layer as well as the printing.

Optionally, an information storage device can be provided on or along either one or both surfaces of the section of polymeric material. In the exemplary embodiment shown, a magnetic strip 714 is shown disposed along bottom surface 708. It will be appreciated, however, that any other suitable construction can alternately be used. Additionally, a second overlay (not shown) could optionally be provided and secured along second surface 708. Such a second overlay would be operative to protect the second surface of the first layer, as well as protect any printing or marking that may be included along the second surface.

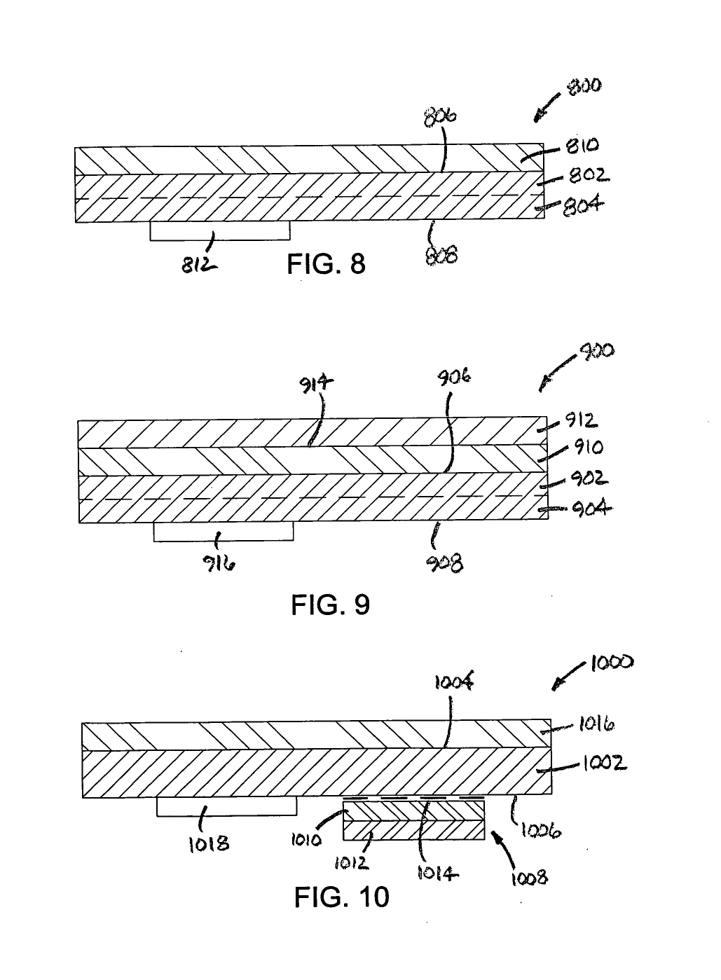

FIG. 8 is a cross-sectional side view of a further embodiment of a section of polymeric material 800 that is suitable for use as a sheet of plastic card stock or a plastic card. Section of polymeric material 800 includes a first layer 802, a second layer 804, a first or top surface 806, and an opposing second or bottom surface 808. In one exemplary embodiment, either one or both of first layer 802 and second layer 804 can be constructed of a material comprising recycled scrap material. In another exemplary embodiment, either one or both of first layer 802 and second layer 804 can be constructed of a material comprising a mixture of recycled scrap material and virgin polymeric material.

In the exemplary embodiment shown in FIG. 8, section 800 includes a first veneer 810 disposed along first surface 806. Typically, the first veneer is included for informational or aesthetic purposes and, thus, includes printing or marking integrally formed thereon. However, first veneer 810 can optionally include an approximately transparent portion (not shown). Additionally, printing or other markings (not shown) can be provided on or along one or both of surfaces 806 and 808 of section 800.

Optionally, an information storage device can be provided on or along either one or both surfaces of the section of polymeric material. In the exemplary embodiment shown, a magnetic strip 812 is shown disposed along bottom surface 808. It will be appreciated, however, that any other suitable construction can alternately be used. Additionally, a second veneer (not shown) could optionally be provided and secured along second surface 808. Such a second veneer may be disposed along the second surface to provide additional information or for aesthetic purposes, for example.

FIG. 9 is a cross-sectional side view of a further embodiment of a section of polymeric material 900 that is suitable for use as a sheet of plastic card stock or a plastic card. Section of polymeric material 900 includes a first layer 902, a second layer 904, a first or top surface 906, and an opposing second or bottom surface 908. In one exemplary embodiment, either one or both of first layer 902 and second layer 904 can be constructed of a material comprising recycled scrap material. In another exemplary embodiment, either one or both of first layer 902 and second layer 904 can be constructed of a material comprising a mixture of recycled scrap material and virgin polymeric material.

In the exemplary embodiment shown in FIG. 9, section 900 includes a first veneer 910 disposed along first surface 906 and a first overlay 912 disposed along an outer surface 914 of first veneer 910. Typically, the first veneer is included for informational, aesthetic or other purposes and, thus, normally includes printing or other markings (not shown) that are integrally formed thereon. However, first veneer 910 can optionally include an approximately transparent portion (not shown). Printing or other markings (not shown) can be provided on or along one or both of surfaces 906 and 908 of section 900.

Optionally, an information storage device can be provided on or along either one or both surfaces of the section of polymeric material. In the exemplary embodiment shown, a magnetic strip 916 is shown disposed along bottom surface 908. It will be appreciated, however, that any other suitable construction can alternately be used. Additionally, either one or both of a second veneer (not shown) and a second overlay (not shown) could optionally be provided and secured along second surface 908 of section 900. Such a second veneer, if provided, may be disposed along the second surface to provide additional information or aesthetics, for example. And, such a second overlay, if provided, may be disposed along the second surface or the second veneer to at least partially protect the same.

FIG. 10 is a cross-sectional side view of still another embodiment of a section of polymeric material 1000 that is suitable for use as a sheet of plastic card stock or a plastic card. Section of polymeric material 1000 includes a first layer 1002 having a first or top surface 1004 and an opposing second or bottom surface 1006. In one exemplary embodiment, first layer 1002 can be constructed of a material comprising recycled scrap material. In another embodiment, first layer 1002 can be constructed of a material comprising a mixture of recycled scrap material and virgin polymeric material.

An optional removable layer, such as a scratch-off label 1008, can be included on either one or both of surfaces 1004 and 1006. In the exemplary embodiment shown in FIG. 10, scratch-off label 1008 includes an approximately transparent polymeric layer 1010 and a removable opaque coating 1012 disposed along bottom surface 1006 of first layer 1002 overtop of transparent polymeric layer 1010. Generally, printing or markings will be provided on a surface of the section of polymeric material, such as printing 1014 disposed along bottom surface 1006, and scratch-off label 1008 will be disposed along the surface to obscure or hide the printing or markings. The printing or markings can be revealed by removing opaque coating 1012 of scratch-off label 1008.

Additionally, an optional veneer can be disposed along either one or both of surfaces 1004 and 1006. In the exemplary embodiment shown in FIG. 10, a first veneer 1016 is disposed along first surface 1004. Typically, the first veneer is included for informational, aesthetic or other purposes and, thus, normally includes printing or other markings (not shown) that are integrally formed thereon. However, first veneer 1016 can optionally include an approximately transparent portion (not shown). Additional printing or other markings (not shown) can optionally be provided on or along one or both of surfaces 1004 and 1006 of first layer 1002.

Optionally, an information storage device can be provided on or along either one or both surfaces of the section of polymeric material. In the exemplary embodiment shown, a magnetic strip 1018 is shown disposed along bottom surface 1006. It will be appreciated, however, that any other suitable construction can alternately be used.

Transparent polymeric layer 1010 can generally be made from any polymeric material including, polyesters, polystyrenes, polypropylene, polysulfone, alamide, polycarbonate, polyvinylalcohol, polyvinylchloride, and the like. In one preferred embodiment, polymeric layer 1010 is formed from the same family of polymeric material as the recycled scrap material or the virgin polymeric material. For example, a section of polymeric material can be constructed from a material comprising recycled PVC, and polymeric layer 1010 of the scratch-off label comprises PVC.

Removable opaque coating 1012 can be formed from any suitable material that can be removed or partially removed by scraping, scratching or another similar action. Materials suitable for use as a removable opaque coating are known in the art. Additionally, the removable opaque coating may be applied by any suitable method including, but not limited to, heat, pressure, adhesive, and the like.

It will be appreciated that any of the foregoing exemplary sections of polymeric material or others suitable for use in forming a sheet of plastic card stock or for use as plastic cards, including, without limitation, those described above with regard to FIGS. 2-10, may be constructed from a material comprising, consisting essentially of, or consisting of recycled polymeric scrap material. Additionally, it will be appreciated that the various constructions described herein can include one or more other devices or components of any suitable type or kind applied on or embedded therein, such as IC chips, for example.

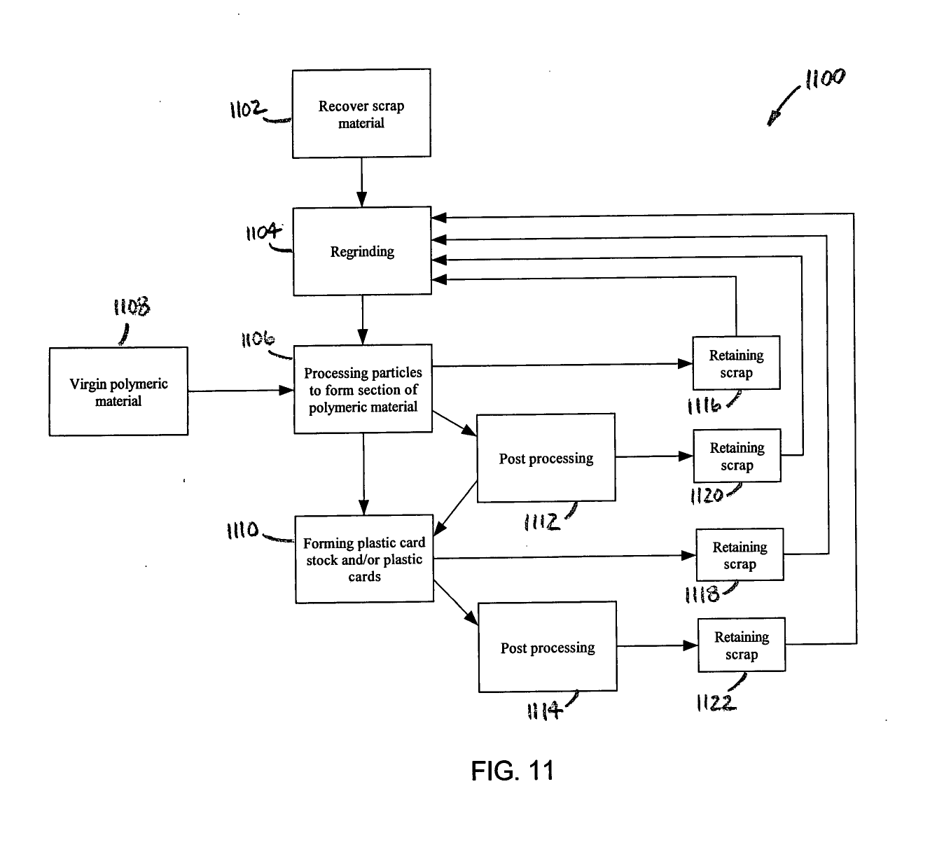

Turning now to FIG. 11, a method 1100 for manufacturing a section of polymeric material comprising recycled scrap material is provided that is suitable for use in forming a sheet of plastic card stock or for use as plastic cards. Method 1100 includes recovering scrap material from a source, as indicated by box 1102. Scrap material may be recovered from any suitable scrap polymeric material source or product that may be recycled to provide recycled scrap polymeric material suitable for use in manufacturing a plastic card.

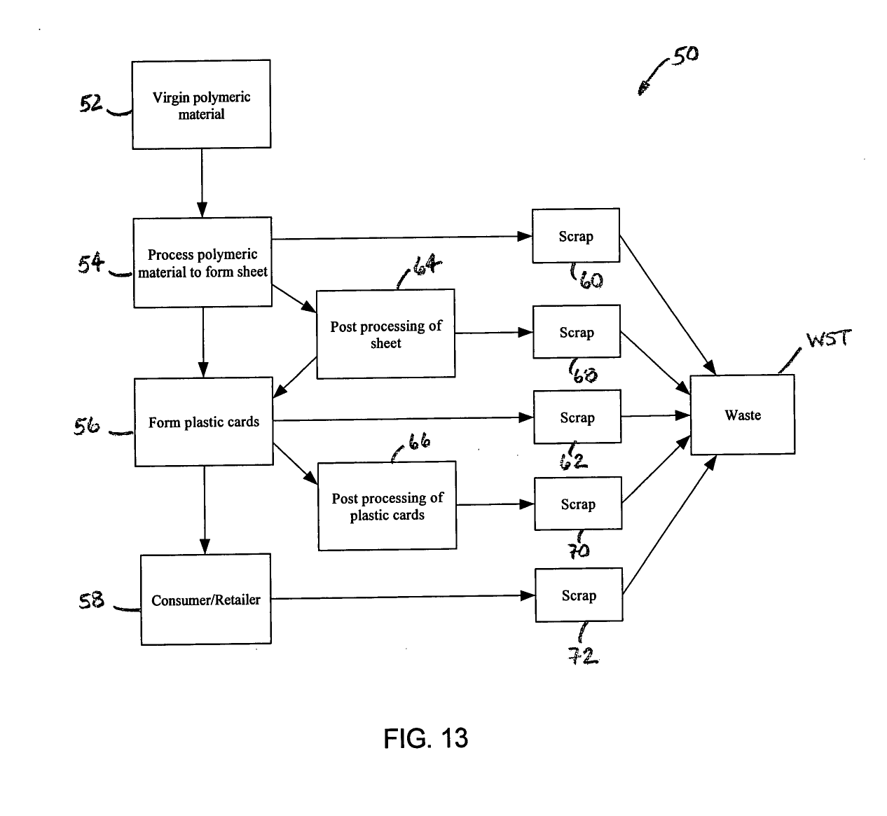

In one embodiment, polymeric scrap material is recovered from one or more plastic card stock and/or plastic card manufacturing processes. For example, as described above with reference to FIG. 13, scrap material such as scrap 60, 62, 68, 70 and/or 72 is produced at various processing steps including, for example, forming a plastic sheet, post processing of the plastic sheet, formation of the plastic cards, and/or post processing of the plastic cards. Thus, for example, scrap produced in a process in FIG. 13 may be recovered in accordance with the present novel concept, such as in box 1102 of method 1100, rather than simply being discarded as waste. Additionally or in the alterative, scrap material may be recovered from post-consumer scrap, e.g. discarded or used plastic cards, collected from retailers and/or directly from consumers (e.g., scrap 72 in FIG. 13). As such, the recovered scrap material may comprise a combination of scrap material recovered from a plastic card manufacturing process, post consumer scrap collected from retailers and/or customers, and/or other sources of scrap polymeric material.

As used herein, recovering scrap material includes any action to obtain scrap material including arranging or enabling others to deposit or collect scrap material. In one embodiment, recovering scrap material may include, for example, directly collecting scrap material from a source such as a retailer or consumer. In another embodiment, recovering scrap material may include arranging for a retailer to (i) collect cards after they have been used or discarded and (ii) provide those cards to the party who will use the scrap material to produce card stock or plastic cards from recycled scrap material. In still another embodiment, recovering scrap material may include arranging for post-consumer scrap to be collected such as, for example, providing receptacles at a selected location wherein consumers (including retailers) can deposit spent or used plastic cards.

As indicated in box 1104, method 1100 also includes regrinding the polymeric scrap material to produce scrap polymeric particles suitable for use in forming a section of polymeric material that is suitable for use in forming a sheet of plastic card stock or for use as plastic cards. As previously described, regrinding the recovered scrap material includes any method or process suitable for rendering the scrap polymeric material into particles having a particle size sufficient for use in a subsequent manufacturing processes, such as calendaring, extruding and/or co-extruding, for example. Examples of suitable regrinding methods include, but are not limited to, grinding, shredding, pulverizing, and the like.

The plastic particles produced by regrinding, which are now referred to herein as recycled polymeric scrap material, are then suitable for processing into a desired form. As indicated by box 1106, method 1100 includes processing the plastic particles into a section of polymeric material comprising recycled polymeric scrap material. The section can be formed using any suitable plastics processing method or operation, including continuous processes (e.g., extrusion) or non-continuous processes. Suitable plastics processing methods include, but are not limited to, calendaring, extrusion, co-extrusion, and the like.

As discussed above, sheets of plastic card stock and/or plastic cards comprising recycled scrap material may comprise a blend of recycled scrap material and virgin polymeric material. As such, method 1100 can optionally include, as indicated in box 1108, providing a quantity of virgin polymeric material and introducing the virgin polymeric material into the processing action in box 1106. This will blend the virgin polymeric material with the recycled polymeric scrap material in forming the section of polymeric sheet material.

Method 1100 also further includes forming a sheet of plastic card stock and/or plastic cards, as indicated by box 1110. Such an action can include any suitable methods, processes and/or operations, including, without limitation, cutting, trimming, shearing, punching, stamping, forming, molding, die cutting, or the like.

Furthermore, method 1100 can optionally include one or more post processing operations, as indicated by boxes 1112 and 1114. Such post processing operations can be performed approximately concurrently with or after forming the section of polymeric material in box 1106 and/or approximately concurrently with or after forming the sheet of plastic card stock or plastic cards in box 1110. Such post processing steps can include any suitable step or series of steps, such as, without limitation, personalization, printing, encoding a magnetic strip, embossing, and scoring, for example.

Method 1100 also optionally provides for in-process recycling of recycled polymeric scrap material. While polymeric scrap material recovered and provided in box 1102 may come from the processing of virgin polymeric materials, it will be appreciated that additional scrap from the already recycled polymeric scrap material will be produced at various steps throughout the process of forming a sheet of plastic card stock and/or a plastic card from the recycled polymeric scrap material. This additional scrap material can be recovered during processing by the manufacturer who can then regrind the scrap and process the reground particles to form a sheet and subsequently form plastic cards. Thus, method 1100 optionally includes retaining scrap, as indicated by box 1116, that is generated by processing the plastic particles into a section of polymeric sheet material in box 1106. Method 1100 can also optionally include retaining scrap, as indicated by box 1118, that is generated by forming a sheet of plastic card stock and/or a plastic card in box 1110. Additionally, method 1100 can optionally include retaining scrap, as respectively indicated by boxes 1120 and 1122, generated by any post processing operations in boxes 1112 and/or 1114.

In another embodiment, a method of manufacturing plastic cards can include one or more of the following steps: (i) recovering polymeric scrap material from a plastic card or a plastic card stock manufacturing process; (ii) grinding, shredding and/or pulverizing the recovered polymeric scrap material into a sufficiently fine particle size in order to render the scrap material fit for use in a subsequent calendaring, extrusion or co-extrusion process; (iii) processing the ground, shredded and/or pulverized scrap material to create a sheet of homogenous recycled scrap material; and (iv) punching a card out of the sheet. Optionally, the method can include the step of winding the sheet of homogenous recycled scrap material into a roll. The method can also optionally include the step of printing one or more characters, logos, or symbols on the sheet after steps (iii) or (iv) discussed above.

In still another embodiment, a method of manufacturing plastic cards includes one or more of the following steps: (i) recovering scrap material from a plastic card or a plastic card stock manufacturing process; (ii) grinding, shredding and/or pulverizing the scrap material into a sufficiently fine particle size in order to render the scrap material fit for use in a subsequent co-extrusion process; (iii) co-extruding the ground, shredded and/or pulverized scrap material with a veneer and/or an overlay to create a sheet of homogenous recycled scrap material with a veneer and/or an overlay; and (iv) punching cards out of the sheet. Optionally, the method can include the step of winding the sheet of homogenous recycled scrap material into a roll. The method can also optionally include the step of printing one or more characters, logos, or symbols on the sheet after steps (iii) or (iv) discussed above.

It is to be understood that the embodiments shown and described herein are merely exemplary and not intended to be limiting. Thus, it will be recognized that various constructions, steps, processes and operations disclosed herein can be combined in any configuration or order and that such combinations are intended to fall within the scope of the present disclosure. For example, in one embodiment, the source of the scrap material may be, all or in part, post-consumer scrap collected from retailers and/or directly from consumers. In another embodiment, virgin material may be blended with the ground, shredded or pulverized polymeric scrap material prior to or during a processing operation, such as a calendaring, extrusion or co-extrusion process, for example. In another embodiment the section of polymeric sheet material may be co-extruded to form two or more layers of recycled polymeric scrap material in a sheet or roll form. In yet another embodiment, the sheet of plastic card stock and/or plastic card can include one or more veneers and/or one or more overlays as well as contain any number of magnetic strips and/or printing or markings as may be desired.

Optionally, a manufacturer producing plastic card stock and/or plastic cards that comprises recycled scrap material may provide an indicia on the plastic card stock and/or plastic cards to identify or indicate that the manufacturer is the source of the card stock or plastic cards. Alternatively, or in addition to source identify indicia, a manufacturer may provide an indicia on the card stock or plastic cards to indicate the class, family, or type of polymeric material present in the card stock or plastic card. Indicia to identify the source and/or type of polymeric material may assist a manufacturer of cards comprising recycled scrap in recovering its own cards or cards of a particular material. This may also aid the recycling process and reduce the need to separate types or classes of polymeric materials from each other prior to processing. Indicia are not limited and may include printing, embossing, stamping or the like, in any shape, symbol, or pattern as desired.

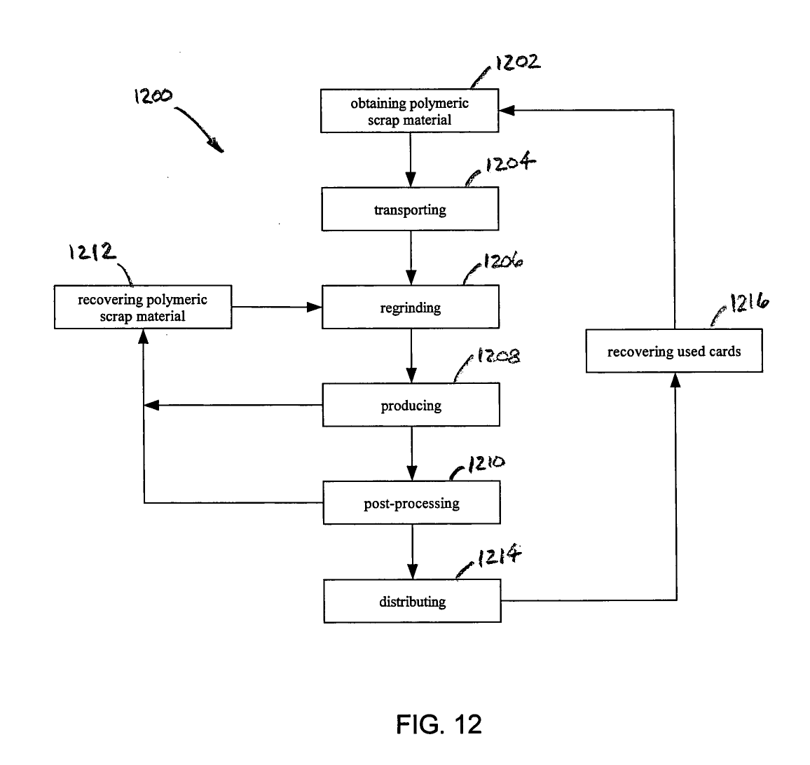

Turning now to FIG. 12, a method 1200 of recycling plastic cards formed from a material comprising recycled polymeric scrap material includes obtaining (which includes arranging for the obtainment of) polymeric scrap material from a third party source, as indicated in box 1202. Third party sources can include any party generating categorized scrap polymeric material, such as other plastic card manufacturers, as well as molders, extruders and other processors, for example. Method 1200 also includes transporting (which includes arranging for the transportation of) the polymeric scrap material to a facility for regrinding, as indicated in box 1204.

Method 1200 further includes regrinding (which includes arranging for regrinding of) the polymeric scrap material into suitably sized plastic particles, as indicated by box 1206. Though not shown in FIG. 12, method 1200 can optionally include transporting (which includes arranging for transportation on the plastic particles or intermediate products formed therefrom to a facility for producing a sheet of plastic card stock or plastic cards. Method 1200 still further includes producing (which includes arranging for the production of) a sheet of plastic card stock or plastic cards formed from material comprising recycled polymeric scrap material, such as from the reground plastic particles, for example, as indicated by box 1208. Method 1200 optionally includes performing (which includes arranging for the performance on one or more post-processing operations, as indicated by box 1210. A variety of exemplary post-processing operations have been discussed above and are not repeated here.

It will be appreciated that the production of a sheet of plastic card stock and/or plastic cards as well as the performance of post-processing operations, as indicated in boxes 1208 and 1210, respectively, will typically include a variety of processes and/or operation. The term post-processing as used herein includes performing (or arranging for the performance on one or more post-processing operations suitable for use in forming plastic card stock or plastic cards. It will be further understood that many of such processes and/or operations may generate additional scrap material comprising the earlier obtained recycled polymeric scrap material. As such, method 1200 can optionally include recovering (which includes arranging for the recovery of) the additional polymeric scrap, as indicated in box 1212. Though not shown in FIG. 12, if such additional polymeric scrap material is recovered, method 1200 can optionally include transporting (which includes arranging for the transport on the additional polymeric scrap material to a facility for regrinding. Such additional material can be thereafter reground, as indicated in box 1206, in conjunction with or in addition to other polymeric scrap materials, such as those provided in box 1202, for example.

Having produced sheets of plastic card stock and/or plastic cards, such as is indicated in boxes 1208 and/or 1210, method 1200 includes distributing (which includes arranging for the distribution of) the sheets of plastic card stock and/or plastic cards to third parties, such as card personalizers, distributors and/or retailers, for example, as indicated in box 1214. Method 1200 further includes recovering used plastic cards from third parties, such as retailers and/or consumers, for example, as indicated in box 1216. Thus, the plastic cards formed originally from recycled polymeric scrap material can themselves become recycled polymeric scrap material used for the production of new plastic cards. This allows for recycled polymeric scrap material to be continuously recycled, which in turn will allow for the amount of virgin polymeric material used in the production of plastic cards to be reduced.

Plastic cards constructed from a material comprising recycled scrap material, methods of forming such cards, and methods for a process that continuously recycles scrap material have been described with reference to the various exemplary embodiments. Modifications and alterations may occur to others upon reading and understanding the preceding detailed description. It is intended that the exemplary embodiment be construed as including all such modifications and alterations insofar as they come within the scope of the appended claims or the equivalents thereof.

1. A section of polymeric sheet material comprising:
a first layer having a first surface and a second surface, the first layer being constructed from a first material comprising recycled scrap material from a single family of polymeric materials.

2. A section of polymeric sheet material according to claim 1, wherein the first material comprises a mixture of recycled scrap material and virgin polymeric material from a single family of polymeric materials.

3. A section of polymeric sheet material according to claim 1 further comprising at least one of a veneer or an overlaying cap disposed along at least one of the first or second surfaces of the first layer.

4. A section of polymeric sheet material according to claim 1 further comprising printed matter disposed along at least one of the first surface or the second surface.

5. A section of polymeric sheet material according to claim 4, wherein the printed matter is disposed along the first side, and said section of polymeric sheet material further comprises a scratch-off label disposed along the first surface and at least partially covering the printed matter.

6. A section of polymeric sheet material according to claim 5, wherein the scratch-off label comprises (i) an approximate transparent layer comprising a second material disposed along the first surface of the first layer, and (ii) a removable opaque material disposed along the approximate transparent layer, the second material being from the same family of polymeric material from which the first layer is constructed.

7. A section of polymeric sheet material according to claim 1 further comprising a second layer disposed along the first layer, the second layer being constructed from a material comprising recycled scrap material.

8. A section of polymeric sheet material according to claim 1, wherein the first material consists essentially of recycled polymeric scrap material.

9. A plastic card formed from a section of polymeric sheet material according to claim 1.

10. A sheet of plastic card stock formed from a section of polymeric sheet material according to claim 1.

11. A method of manufacturing one of a sheet of plastic card stock or a plastic card, the method comprising:
(a) recovering scrap polymeric material;
(b) regrinding the scrap polymeric material to provide recycled polymeric particles,
(c) processing the recycled polymeric particles to form a section of polymeric sheet material comprising recycled scrap polymeric material; and
(d) forming at least one of a sheet of plastic card stock or a plastic card from the section of polymeric sheet material.

12. A method according to claim 11, wherein (a) includes recovering at least one of scrap polymeric material generated during processing of virgin polymeric material, scrap polymeric material generated during processing of recycled scrap material, post-consumer scrap comprising virgin polymeric material, or post-consumer scrap comprising recycled scrap material.

13. The method according to claim 8, wherein (a) includes recovering scrap polymeric material generated during processing of virgin polymeric material in forming a core for a plastic card.

14. The method according to claim 8, wherein (a) includes recovering plastic cards comprising virgin polymeric material.

15. The method according to claim 8, wherein (a) includes recovering plastic cards comprising recycled scrap material.

16. A method for forming one of a sheet of plastic card stock or a plastic card comprising recycled scrap material, the method comprising:
(a) recovering scrap polymeric material from a source;
(b) regrinding the scrap polymeric material to provide recycled scrap polymeric particles;
(c) processing the recycled scrap polymeric particles to form a section of polymeric sheet material comprising recycled scrap material; and
(d) forming one of a sheet of plastic or a plastic card comprising recycled scrap material.

17. A method according to claim 16, wherein a) includes recovering scrap polymeric material generated during an earlier occurrence of at least one of steps (c) or (d).

18. A method according to claim 16 further comprising blending a quantity of virgin polymeric material into one of (b) or (c) to produce a section of polymeric sheet material comprising recycled scrap material and virgin polymeric material.

19. A method according to claim 16, further comprising performing a post processing operation on the section of polymeric sheet material produced in step (c).

20. A method according to claim 19, wherein the post processing operation includes generating scrap polymeric material, and the method further comprises recovering the scrap polymeric material in (a).

21. The method according to claim 16, further comprising performing a post processing operation on one of a sheet of plastic card stock or a plastic card formed in step (d).

22. A method according to claim 21, wherein the post processing operation includes generating scrap polymeric material, and the method further comprises recovering the scrap polymeric material in (a).

23. The method according to claim 16, further comprising:
(e) providing a plurality of plastic cards to a party;
(f) recovering at least a portion of the plurality of plastic cards from a party after being used for their intended purpose; and
(g) regrinding the portion of plastic cards in step (b).

24. A method for recycling scrap polymeric material into one of a sheet of plastic card stock or a plastic card, the method comprising:
(a) recovering scrap polymeric material from a first party;
(b) regrinding the scrap polymeric material into recycled scrap polymeric particles;
(c) processing the recycled scrap polymeric particles into a section of polymeric sheet material comprising recycled scrap polymeric material;
(d) processing the section of polymeric sheet material into at least one of a sheet of plastic card stock or a plastic card comprising recycled scrap polymeric material; and
(e) distributing the at least one sheet of plastic card stock or plastic cards to a second party.

25. A method according to claim 24, wherein (a) includes recovering scrap polymeric material from at least one of plastic card consumers, plastic card manufacturers, and combinations thereof.

26. The method according to claim 24 further comprising:
(f) recovering the at least one plastic card comprising recycled scrap polymeric material from one of the second party or a third party after the copy has been used, the recovered at least one plastic card comprising recycled scrap material now being considered scrap polymeric material; and
(g) repeating (b)-(e) with the scrap polymeric material recovered in (f).

27. The method according to claim 26, wherein (f) and (g) are continuously repeated.

28. The method according to claim 24 further comprising recovering scrap material produced from at least one of forming stock material in (c) or forming the at least one plastic card in (d) and recycling such scrap material back to (b).

29. The method according to claim 24, wherein the scrap polymeric material in (a) comprises plastic cards formed from virgin polymeric material.

30. The method according to claim 24, wherein the scrap polymeric material in (a) comprises plastic cards formed from a material comprising recycled scrap material.

31. The method according to claim 24, wherein the scrap polymeric material in (a) comprises scrap material produced during processing of virgin polymeric material to form at least one of stock material suitable for forming plastic cards or formation of plastic cards from stock material comprising virgin polymeric material.
